(19) United States
(12) Patent Application Publication
(10) Pub. No.: US 2020/0128846 A1
(43) Pub. Date: Apr. 30, 2020

(54) SELF WARMING CANDY

(71) Applicant: Mey Seang Chhay, Durham, NC (US)

(72) Inventor: Mey Seang Chhay, Durham, NC (US)

(21) Appl. No.: 16/175,119

(22) Filed: Oct. 30, 2018

(51) Int. Cl. A23G 1/54; A23G 1/32; F24V 30/00

(52) U.S. Cl. CPC A23G 1/54; A23V 2002/00; F24V 30/00; A23G 1/32

(57) ABSTRACT

The present invention is a candy that warms with an exothermic composition sufficient to not heat the candy past the candy's melting point or body temperature.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a candy food product. In particular, it relates to a self-warming candy such as chocolate.

### Description of Related Art

The idea of heating foods like coffee or meals to serving temperature, roughly 150 degrees F. and higher, has been done for a long time. Self-heating without the use of some kind of burner or oven has advantages in certain situations like camping emergencies and the like.

Self-heating can be done and is known in the art to be either external or internal. External heating involves exothermic chemical reactions wherein the heat is transferred to the food and is present in enough quantity to raise the temperature to serving temperature. Internal heating refers to exothermic chemicals which are food safe and can be utilized in a food. However, the use of these compositions has always been for the purpose of raising temperatures close to the boiling point of water and not much else.

It is clear that even though this technology to cooking temperatures is valuable, it has not been applied or designed past that of cooking foods.

### BRIEF SUMMARY OF THE INVENTION

The present invention relates to the discovery that while candy is not usually served warm on purpose, warming candy above ambient temperature to no more than about body temperature can add to the enjoyment of candies' taste as long as the candy is not heated above the melting point of the candy. For example, chocolate melts somewhere between about 86 and 90 degrees F.

Accordingly, in one embodiment, there is a candy product comprising a piece of candy with a chemical product that delivers an exothermic reaction wherein the product is limited in the candy to just enough to warm the candy to be just over ambient temperature to no more than about body temperature.

In another embodiment, there is a method for delivering a warmed piece of candy comprising:
a) selecting a piece of candy; and
b) associating the candy with a chemical product in just enough quantity to warm the candy from about ambient temperature to about body temperature.

### BRIEF DESCRIPTION OF THE DRAWINGS

FIG. 1 is a perspective view of the candy product of the invention.

FIG. 2 is a perspective view of the candy product of the present invention wherein the chemical product is incorporated into the piece of candy.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “candy product” refers to a piece of candy that is associated with an exothermic chemical product.

As used herein, the term “piece of candy” refers to an individual piece of a heavily sugared product such as chocolate, hard candy, gummies, lollipops, suckers, jellybeans, candy bars, gum, powdered candy, soft candy, taffy, and the like.

As used herein, the term “associated” refers to the exothermic chemical product positioned either in the candy or next to the candy close enough to warm the candy as described herein.

As used herein, the term “chemical product” refers to chemicals (usually two though more are possible) that when allowed to react together in an exothermic reaction to produce heat. Reaction can take place by mixing the components of the chemical process in any manner. The amount needed is just enough to warm the candy without melting it, in general, from ambient (about 70° F.) to about human body temperature. Many compositions are well known for heating up food products to a cooking temperature. These compositions are used either in the candy or next to it in a quantity sufficient that the candy is only warmed and not cooked or melted. In one embodiment, the candy is warmed over ambient temperatures.

As used herein, the term “warm” refers to heating to either just below the melting point of the candy (such as chocolate) or about ambient temperature to about body temperature, i.e. 98.6 degrees F.

### DRAWINGS

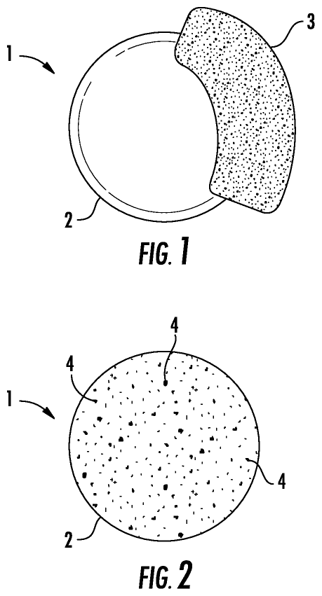

Now referring to the drawings, FIG. 1 is a perspective view of the candy product 1 of the invention. In this view, candy (chocolate, in this example) 2 is in contact (associated) with an exothermic chemical product 3 which upon mixing of the ingredients therein creates enough warming heat to heat the candy to less that its melting point.

FIG. 2 is a perspective view of the candy product 1 wherein the chemical product 4 is incorporated into the piece of candy 2 in just enough quantity to warm the candy.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A candy product comprising a piece of candy with a chemical product that delivers an exothermic reaction wherein the product is limited in the candy to just enough to warm the candy to be just over ambient temperature to no more than about body temperature.

2. The candy according to claim 1 wherein the candy is a chocolate heated between above ambient to less than about the melting point of the chocolate.

3. The candy according to claim 1 wherein the product is in the candy.

4. The candy according to claim 1 where the product is next to the candy positioned for warming the candy.

5. A method for delivering a warmed piece of candy comprising:
a) selecting a piece of candy; and
b) associating the candy with a chemical product in just enough quantity to warm the candy from about ambient temperature to about body temperature.
